(19) United States
(12) Patent Application Publication
(10) Pub. No.: US 2017/0280107 A1
(43) Pub. Date: Sep. 28, 2017

(54) SITE SENTINEL SYSTEMS AND METHODS

(71) Applicant: AllSource Analysis, Inc., Longmont, CO (US)

(72) Inventors: Stephen A. Wood, Longmont, CO (US); Charles P. Herring, Longmont, CO (US); Joseph S. Bermudez, JR., Longmont, CO (US); James Michael Eley, Fort Collins, CO (US); Ryan Carr, Centennial, CO (US); Ken Carter, Castle Pines, CO (US)

(21) Appl. No.: 15/472,079

(22) Filed: Mar. 28, 2017

Related U.S. Application Data
(60) Provisional application No. 62/314,220, filed on Mar. 28, 2016.

(51) Int. Cl. H04N 7/18; G06K 9/00; G06Q 50/00; B64D 47/08; G05D 1/00; G06K 9/62; B64C 39/02

(52) U.S. Cl. CPC H04N 7/181; G06K 9/6288; G06K 9/0063; G06K 9/00771; B64C 39/024; B64D 47/08; G05D 1/0011; G06Q 50/01; B64C 2201/123; B64C 2201/127; B64C 2201/146

(57) ABSTRACT

Systems and methods disclosed herein provide advanced security and situational awareness solutions enabling, real-time intelligence and a rapid response capability for businesses, first responders and off-site personnel needing real-time information to plan short-, mid- and long-term responses to specific situations. Site sentinel systems and methods include a digital representation of a site, at least one detection sensor for monitoring the site, a sensor signature analyzer for processing data from each detection sensor to identify site abnormalities, and an analytics engine for generating output that synthesizes the digital representation with graphics positioning site abnormalities. The sentinel system may further include at least one drone for providing aerial reconnaissance of the site that is directed by a drone controller in response to identified site abnormalities.

### RELATED APPLICATIONS

This application claims priority to U.S. Patent Application Ser. No. 62/314,220, titled “Site Sentinel Systems and Methods”, filed Mar. 28, 2016, and incorporated herein by reference.

### BACKGROUND

Current public safety and business security operations are often passive and reactive, usually responding only after an event is in progress or has already occurred. Frequently, operations focus heavily on security personnel using cameras and a small suite of facility sensors that provide a limited view and offer inadequate situational awareness. Technologies exist that assist safety and security customers but they are often disparate and complex making it difficult to implement and use effectively.

### SUMMARY

Systems and methods disclosed herein provide advanced security and situational awareness solutions enabling, real-time intelligence and a rapid response capability for businesses, first responders and off-site personnel needing real-time information to plan short-, mid- and long-term responses to specific situations. These systems and methods for example help proactively prepare, detect, respond and resolve critical issues that threaten people, organizations and property. Certain systems and methods utilize satellites, drones, sensors, social media monitoring and mobile technologies integrated with software and data analytics to improve preparedness and deliver comprehensive situational awareness. By looking at security and risk from multiple vantage points, systems and methods disclosed herein may help provide a useful operating structure that integrates information and capabilities from a wide variety of data sources into a secure, on-line platform to help protect critical business assets, infrastructure and employee health and safety and to enable better decisions, based on actionable intelligence before, during and after a crisis event, by security teams, off site personnel (e.g., managers), and/or first responders.

In one embodiment, a site sentinel system has: a digital representation of a site; at least one detection sensor for monitoring the site; a sensor signature analyzer for processing data from each detection sensor to identify site abnormalities; and analytics engine for generating output that synthesizes the digital representation with graphics positioning site abnormalities.

In one embodiment, a method determines baseline risks at a site, including: capturing a digital representation of the site; determining a property outline of the site; determining at least one key asset outline of the site; determining one or more ports to the site and/or to the key asset; and synthesizing data representative of the property outline, key asset and ports as graphic data with the digital representation as output graphics useful in responding to site abnormalities at the site.

In another embodiment, a method identifies and markets an information product. External data and imagery is gathered in real-time and processed to identify an event of interest. The information product is defined by interacting with at least one of a plurality of analysts via an online production platform. The information product is generated based upon the gathered external data and imagery corresponding to the identified event of interest and the information product is marketed to one or more customers through a marketplace platform.

### BRIEF DESCRIPTION OF THE FIGURES

FIG. 1 shows one site sentinel system, in an embodiment.

FIG. 2 shows certain components of the site sentinel system of FIG. 1, and in further detail, illustrating example operation to assess a site and generate the digital representation of FIG. 1, in an embodiment.

FIG. 3 illustrates example output corresponding to the digital representation of FIG. 2, in an embodiment.

FIG. 4 is a flowchart illustrating one example site sentinel method, in an embodiment.

FIG. 5 shows certain components of the site sentinel system of FIG. 1 as used in an operational phase, in an embodiment.

FIG. 6 illustrates example output corresponding to the digital representation of FIG. 2 and enhanced by the graphics generator of FIG. 5 based upon determined situation data, in an embodiment.

FIG. 7 shows one example detection sensor that represents one of the detection sensors of FIG. 1, in an embodiment.

FIG. 8 is a schematic illustrating one example marketplace for the sentinel system of FIG. 1, in an embodiment.

### DETAILED DESCRIPTION OF THE EMBODIMENTS

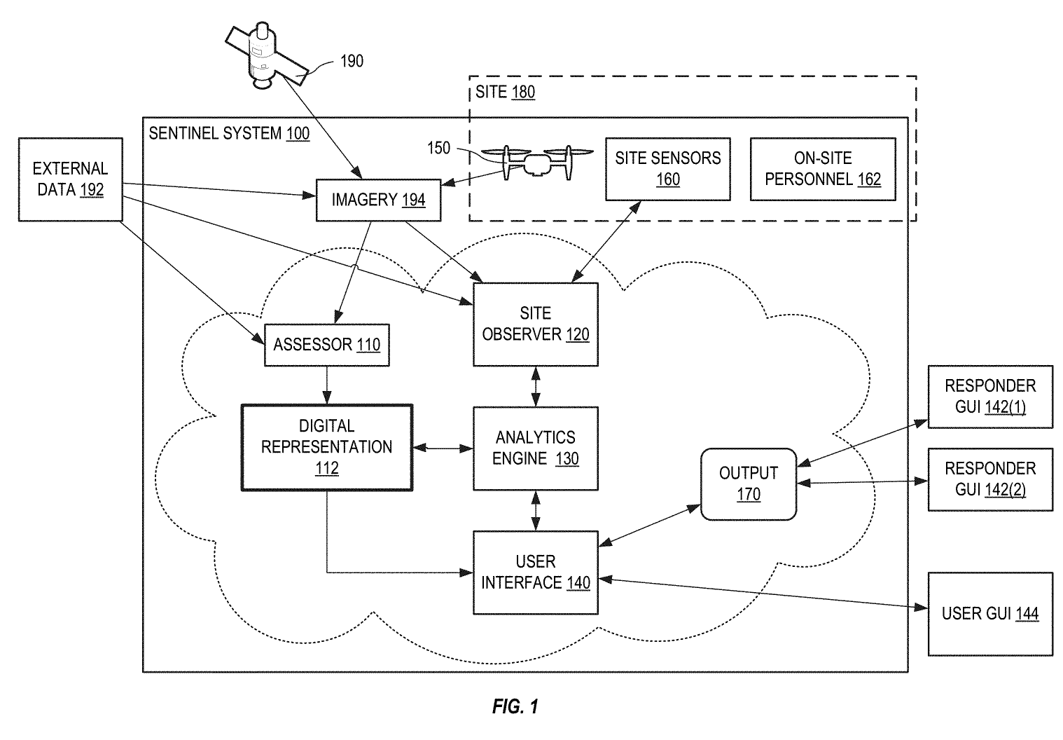

FIG. 1 shows a site sentinel system 100 for assessing and monitoring a site 180. Sentinel system 100 includes an assessor 110 that assesses site 180 and generates a digital representation 112 of site 180. Digital representation 112 for example defines location, shape, size, features, assets and vulnerabilities of site 180. Sentinel system 100 also includes a site observer 120 and an analytics engine 130 that cooperate to monitor site 180 for abnormalities. One or more site sensors 160 are positioned at optimal locations within site 180 based upon evaluation of digital representation 112 by analytics engine 130. One or more drones 150 fly reconnaissance over site 180 to collect imagery 194 that is used by site observer 120 and/or analytics engine 130 to baseline site 180, evaluate identified anomalies within site 180, and/or monitor site 180 after identified abnormalities. Sentinel system 100 includes a user interface 140 that provides one or more outputs 170 that may for example be viewed by first responders on mobile devices, illustratively shown as responder graphical user interfaces (GUIs) 142. User interface 140 may also provide for access and control of system 100 via a user GUI 144.

Functionality and operation of site sentinel system 100 may be considered in two separate phases: (1) a baseline phase for site selection and assessment, and (2) an operational phase for site monitoring and event handling. These two phases will be independently described in the following description and associated figures for clarity.

### Baseline Phase

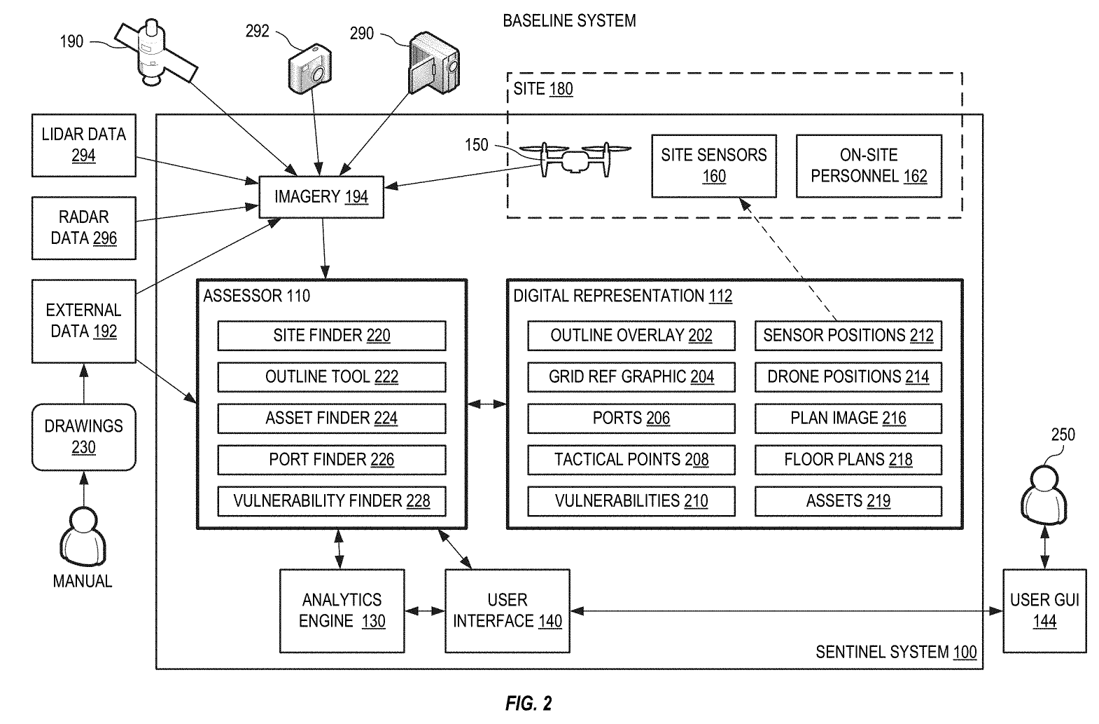

FIG. 2 shows certain components of site sentinel system 100 in further detail and illustrating example operation to assess site 180 and generate digital representation 112. Assessor 110 includes a site finder 220, an outline tool 222, an asset finder 224, a port finder 226, and a vulnerability finder 228 that cooperate to process external data 192 and imagery 194 corresponding to site 180 to generate digital representation 112. External data 192 represents any one or more databases of information that are external to system 100, such as civil data corresponding to property ownership, city records and municipality data, geological data, social media, and other such information. External data 192 may also represent databases that are purchased for use by system 100.

In one embodiment, site finder 220 interacts with a user (e.g., via user interface 140 and user GUI 144) to select site 180. For example, where a user requires assessment and monitoring of a particular site, the user may interactively define the location by selecting on a map and/or satellite imagery. In another embodiment, site finder 220 operates autonomously to identify certain site types (e.g., petrochemical plants, archeological sites, and so on) within an area (e.g., a certain country or county or city) specified by a user. In another embodiment, system 100 automatically and systematically identifies and assesses vulnerabilities of sites (e.g., oil refineries, financial sites) within a certain area or country. In one example of operation, site finder 220 processes external data 192 and/or imagery 194 from one or more of satellite 190, ground video camera 290, ground still camera 292, and drone 150, and/or manual drawings 230, to identify site 180.

Once site 180 is identified, assessor 110 invokes outline tool 222, asset finder 224, and port finder 226 to process the selected external data 192 and/or imagery 194 corresponding to site 180 and generate digital representation 112 for site 180. For example, where specific data relating to a boundary of site 180 is not available, outline tool 222 may process imagery 194 to synthesize outline overlay 202. In another example, assessor 110 utilizes property outline information from an external source such as a county property database (at external data 192) to determine an appropriate outline.

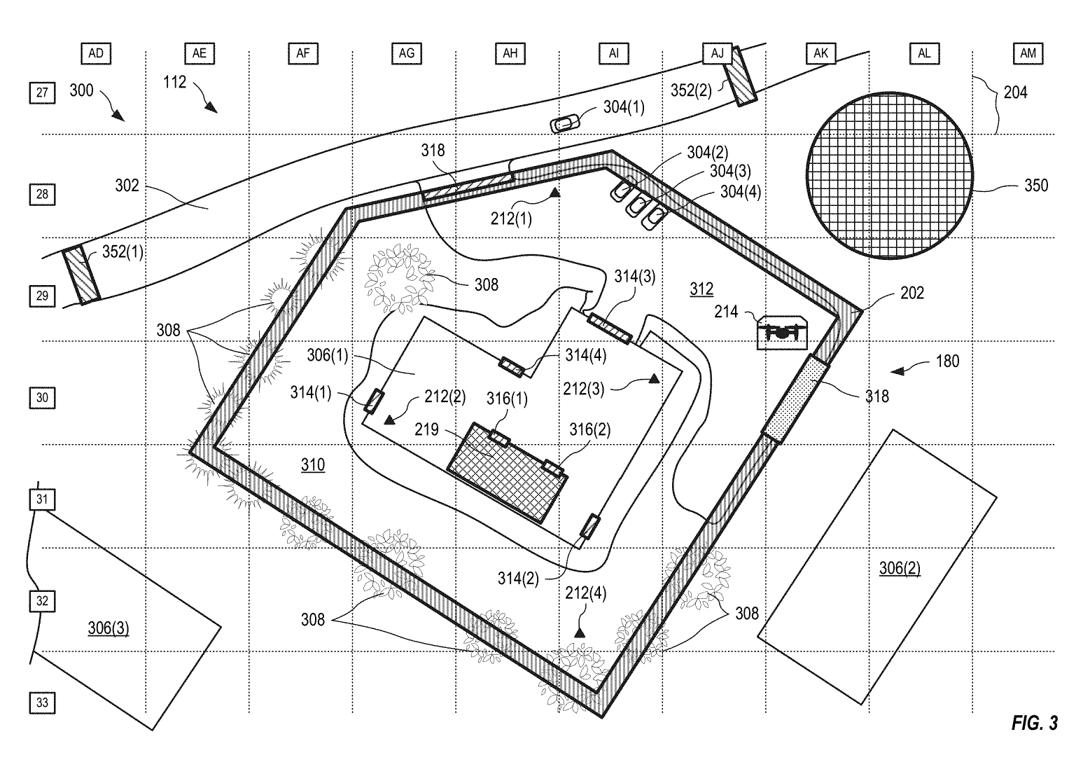

FIG. 3 illustrates example output 300 (e.g., output 170 corresponding to digital representation 112 of FIG. 1 or 2). FIGS. 2 and 3 are best viewed together with the following description. System 100 may deliver information in formats other than GUIs 142, 144. For example, output 170 may be delivered by one or more of a portal, physical media, file transfer protocol (FTP), web service, email, web portal, and briefcase, without departing from the scope hereof.

Output 300, as shown in FIG. 3, incorporates at least part of aerial plan image 216 of FIG. 2, and shows site 180 with a road 302, a vehicle 304, buildings 306, trees 308, grass 310, and concrete 312. In the example of FIG. 3, building 306(1) is within site 180 and is, in this example, a building of interest. Output 300 is for example generated by cropping and scaling an aerial, satellite, and/or drone image of the area from imagery 194 based upon location and size of site 180 to form a plan image 216, and then by enhancing this representation by adding one or more of outline overlay 202, grid reference graphic 204, ports 206, tactical points 208, vulnerabilities 210, sensor positions 212, drone positions 214, and floor plans 218.

Assessor 110 invokes outline tool 222 to process external data 192 and/or imagery 194 to generate outline overlay 202 of site 180, where for example outline overlay 202 defines a boundary of site 180. Within output 300, outline overlay 202 thus enhances visibility—and locational awareness—of site 180 to a user. In an alternate embodiment, outline tool 222 interacts with a user, via user interface 140 and user GUI 144, to generate outline overlay 202. In one example of operation, outline tool 222 retrieves and processes municipal data corresponding to site 180 from external data 192 to determine the boundary of site 180 and then generates outline overlay 202 therefrom. In another example of operation, outline tool 222 retrieves and processes aerial images from imagery 194 to estimate (i.e., using image processing and recognition techniques) outline overlay 202 of site 180.

Assessor 110 invokes asset finder 224 to identify at least one asset 219 of interest within site 180. Assets 219 may include particularly valuable areas, such as a laboratory, fabrication area, processing area, storage area, petrochemical tanks, utilities, utility right of ways, and so on. That is, assets 219 are areas that are potential targets for attack, theft, or other malicious activity by third parties and that are to be protected within site 180. As shown in FIG. 3, assets 219 are highlighted within output 300, thereby allowing users of output 300 to easily identify important and/or valuable areas within site 180. In one embodiment, assets 219 may also identify on-site personnel. In another embodiment, assets 219 are identified through online databases or social media (see, e.g., external data 192 FIG. 2) or even by property assessment databases.

Assessor 110 invokes port finder 226 to identify ports 206 within and around site 180. Ports 206 represent areas of ingress/egress, such as one or more of external building doors 314, internal doors 316, gateways 318, and so on. As shown in FIG. 3, ports 206 (shown as building doors 314, internal doors 316, and gateway 318) are highlighted within output 300 for easy assimilation by viewers. In one embodiment, ports 206 are identified through online databases or social media (see, e.g., external data 192 FIG. 2) or even by architect databases.

Assessor 110 invokes vulnerability finder 228 to identify vulnerabilities 210 within site 180. In one example, vulnerability finder 228 processes external data 192 and/or imagery 194 to identify vulnerabilities 210, such as a broken fence, broken or missing gate 318, vegetation near a security fence that could provide concealment to an attacker, and so on. Assessor 110 may then enhance output 300 by highlighting these vulnerabilities 210.

Assessor 110 may also determine one or more tactical points 208 within site 180, illustratively shown in FIG. 3 as designated areas for: helicopter landing area 350, road blocks 352, and may include other areas such as medical treatment areas, evacuation areas, assembly areas, decontamination areas, and so on. In one embodiment, assessor 110 interacts with a user 250 via user interface 140 and user GUI 144 to interactively define tactical points 208. Strategic information may be derived from other sources such as Stratfor that provides remote intelligence analysis.

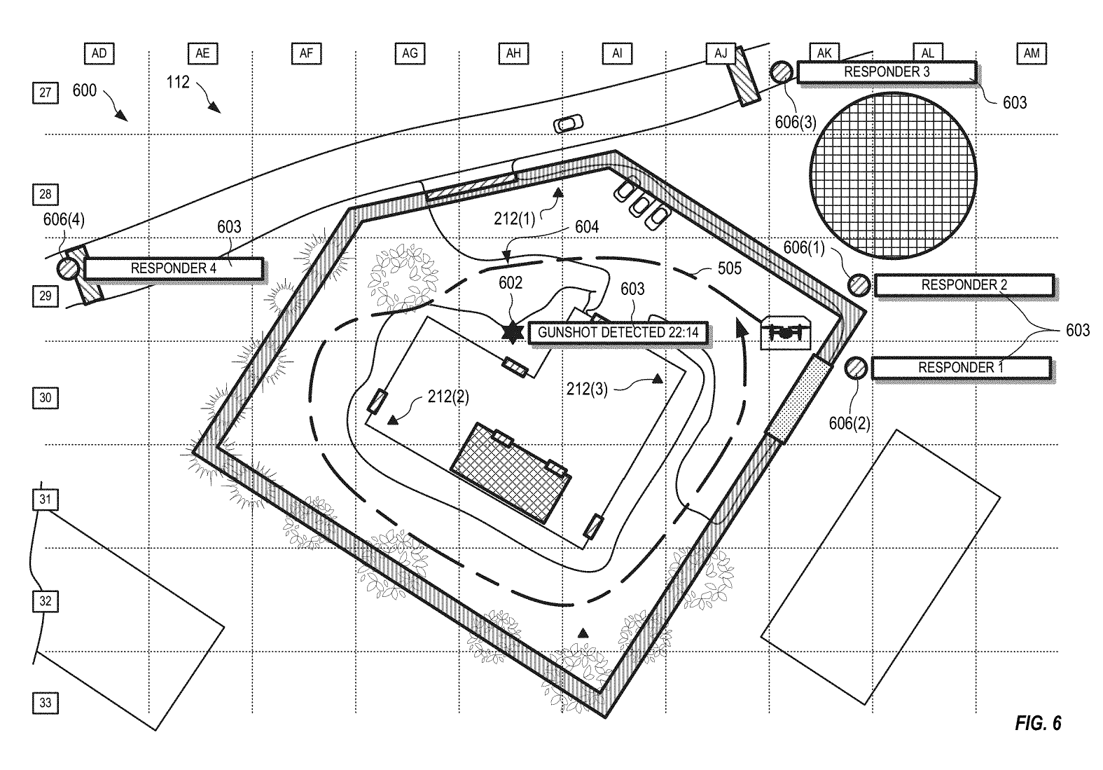

As shown in FIG. 3, grid reference graphic 204 is overlaid onto output 300 to provide a fast consistence geo-reference for site 180. In one embodiment, grid lines are spaced twenty-five meters apart and positioned and labeled consistently for all generated outputs 170. Users can thus coordinate responses according to grid coordinates (see e.g., grid AH29 corresponding to event 602, FIG. 6).

In an embodiment, digital representation 112 is generated from a systematic vulnerability assessment conducted of security and physical surroundings of site 180 using site-appropriate data that may include satellite, aerial and/or drone imagery, light intensity distance and ranging (LIDAR) data 294, radio detection and ranging (RADAR) data 296, and manually generated images (e.g., hand or CAD drawings) collectively shown as imagery 194, FIG. 1. That is, digital representation 112 may be based upon one or more of satellite imagery (e.g., from satellite 190) of site 180, aerial photographs (e.g., from drone 150) of site 180, LIDAR data 294, RADAR data 296, and/or one or more illustrations or data points for site 180. Digital representation 112, also identified herein as a smart image map (SIM), identifies ingress/egress points, floor plans, and identifies tactical information of area surrounding site 180. Digital representation 112 may be printed, stored digitally and accessed through the cloud via a variety of devices including smartphones, tablets, laptops as well as other security systems. Digital representation 112 provides a standardized, common operating picture for personnel as the command center directs response as well as development of an emergency response plan. In one embodiment, digital representation 112 includes a digital 3D model of site 180 that facilitates improved visualization and accuracy. For example, digital representation 112 may include virtual 3D buildings integrated into enterprise software solution that allows computer generated representations of the physical environment of site 180 thereby providing a virtual view of site 180, or part thereof, including buildings, trees, vehicles, and so on. The 3D model of digital representation 112 may include floor plans of a multiple storied building that are displayed collectively within output 170 where the viewing angle is moved (e.g., scaled, panned, rotated) to more accurately depict locations (e.g., locations of events 602, symbols 606 of responders, on-site personnel 162, and so on) to the user.

### Deployment Preparation

In an embodiment, assessor 110 and analytics engine 130 cooperate to determine one or both of sensor positions 212 and drone positioning (corresponding to positions 214, in this example) within site 180. Detection sensors 160 may represent (a) existing sensors positioned within site 180 and/or (b) additional sensors to be deployed at site 180. Where site 180 would benefit from available real-time areal imagery, drone 150 may be housed at site 180 such that it is automatically deployed by system 100, as needed, to collect real-time imagery (such as in real time reconnaissance after detection of an abnormality at site 180 or to baseline conditions at site 180).

In an embodiment, drone 150 includes flight hardware (e.g., inertial and satellite navigation hardware, memory) and associated software facilitating autonomous operation, without continuous communication with site observer 120, such that captured video and other sensed information is stored within memory of drone 150 until mission completion or until communication with site observer 120 is reestablished.

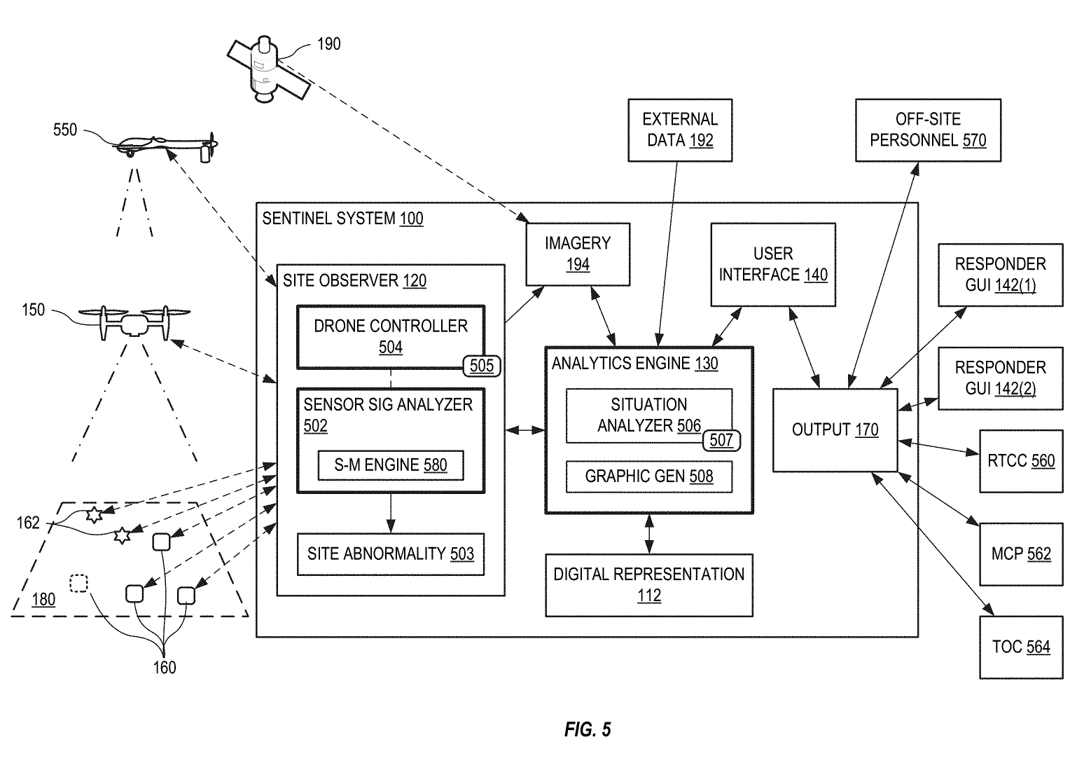

Drone 150 may be installed at site 180 inside a secure drone port (not shown) that is hardened against physical intrusion, is weather-proof, and functions as a charging and communication dock for drone 150. Both drone 150 and the drone port may be remotely programmed and reprogrammed (see, e.g., drone controller 504 of FIG. 5 and the description below). In one embodiment, the drone port includes weather monitoring capability such that localized weather data is collected by site observer 120. In an embodiment, drone 150 is for example secured in a standby mode within the drone port and is loaded with one or more pre-programmed flight plans for autonomous flying over at least part of site 180. In another embodiment, system 100 includes a plurality of drones 150, each having a separate drone port strategically positioned within a different part of site 180, such that, when deployed, each drone 150 follows a different flight plan over and around site 180. Each drone 150 may be equipped with a full motion video camera and a wireless transmitter that functions to transmit captured video to site observer 120. Drone 150 may also include on-board sensors (e.g., motion, IR sensors) that additionally transmit sensor data to site observer 120, as needed.

Once sensors 160 and drone 150 are positioned at site 180, they operationally connect to site observer 120 which in turn may configure, control and/or process data such as taught by the disclosure herein.

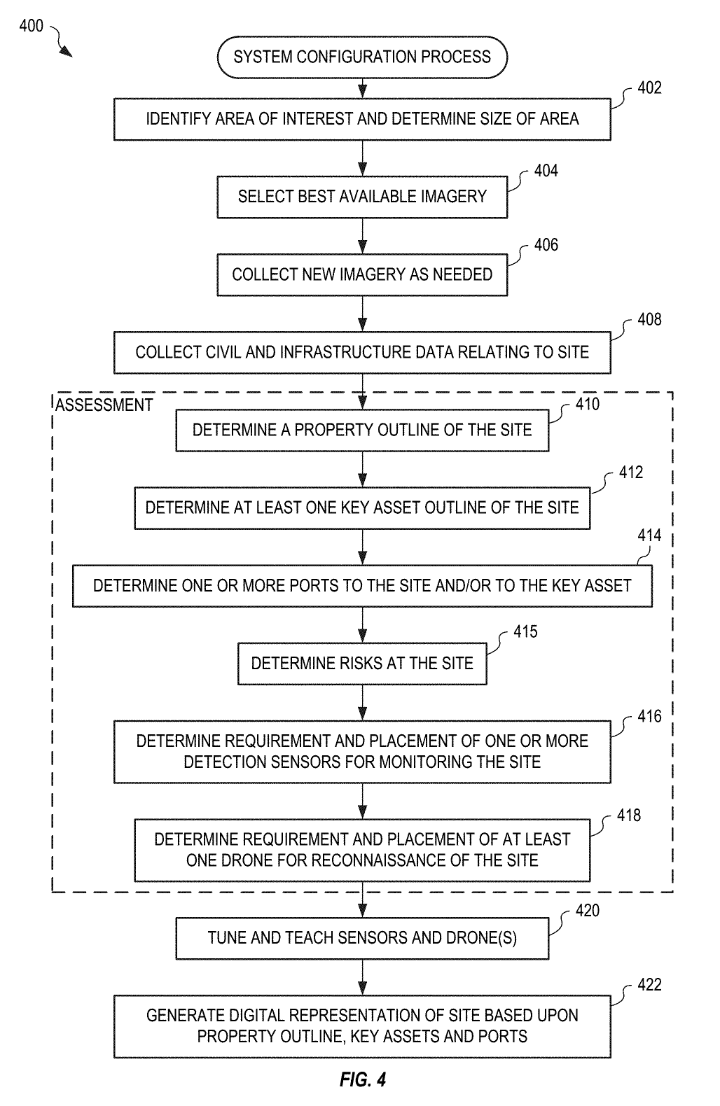

FIG. 4 is a flowchart illustrating one site sentinel method 400; method 400 may be used to assess site 180 of FIG. 1 and determine baseline risks. Method 400 is for example implemented by assessor 110 for performing the baseline phase of sentinel system 100.

In step 402, method 400 identifies an area of interest and determines a size of the area. In one example of step 402, site finder 220 identifies site 180.

In step 404, method 400 selects best available imagery. In one example of step 404, site finder 220 processes imagery 194 to identify the best available imagery (e.g., one or more of overhead, local, ground, photographs and depictions) of site 180. In another example of step 404, ground imagery is obtained that is merely a depiction of site 180.

In step 406, method 400 collects new imagery as needed. In one example of step 406, assessor 110 invokes a digital representation of the site. In one example of step 406, site finder 220 controls (e.g., using drone controller 504 of FIG. 5) drone 150 to capture areal images of site 180. In another example of step 406, a photo of site 180 is obtained.

In step 408, method 400 collects civil and infrastructure data relating to the site. In one example of step 408, assessor 110 searches, if available, external data 192 to retrieve civil and infrastructure information of site 180.

In step 410, method 400 determines a property outline of the site. In one example of step 410, outline tool 222 processes imagery 194 of steps 404 and 406 and data of step 408 to determine outline overlay 202. Alternatively, the property outline is estimated based on geographical evidence in the digital representation; actual property border delineation is desired but not essential.

In step 412, method 400 determines at least one key asset outline of the site. In one example of step 412, asset finder 224 processes imagery 194 of steps 404 and 406 and data of step 408 to determine assets 219. Key assets might for example be shaped as a petrochemical structure that is easily identifiable. Key assets might also be identified through online databases which state, for example, that a certain building houses a complex state of the art laboratory built with high construction cost. In another example, key assets might include archaeological structures already cataloged by anthropologists or archeologists or even a historical society.

In step 414, method 400 determines one or more ports to the site and/or to the key asset. In one example of step 414, port finder 226 processes imagery 194 of steps 404 and 406 and data of step 408 to determine ports 206. In step 415, method 400 determines risks at the site. In one example of step 415, vulnerability finder 228 identifies vulnerabilities 210, such as an opened port or gate, which is flagged as a risk.

In step 416, method 400 determines requirements for, and placement of one or more detection sensors for monitoring the site. In one example of step 416, assessor 110 processes imagery 194 of steps 404 and 406 and data of step 408 to determine sensor positions 212 for detection sensors 160 within site 180.

In step 418, method 400 determines requirement and placement of, at least one drone for reconnaissance of the site. In one example of step 418, assessor 110 processes imagery 194 of steps 404 and 406 and data of step 408 to determine drone positions 214.

In step 420, method 400 tunes and trains (programs) the sensors and drones. In one example of step 420, assessor 110 cooperates with site observer 120 to configure (e.g., program) each sensor 160 and to determine flight plans (e.g., flight plans 505) for drone 150.

In step 422, method 400 generates a digital representation of the site based upon property outline, key assets and ports. In one example of step 422, assessor 110 generates digital representation 112 of site 180 based upon one or more of imagery 194 of steps 404 and 406, data of step 408, outline overlay 202, grid reference graphic 204, ports 206, sensor positions 212, drone positions 214, plan image 216, and floor plans 218.

### Operational Phase

FIG. 5 shows certain components of sentinel system 100 of FIG. 1 as used in an operational phase. Site observer 120 includes a sensor signature analyzer 502 and a drone controller 504, each having machine readable instructions that, when executed by a digital processor, operate to provide the site sentinel functions described herein.

### Detection Sensors

As noted above, a detailed monitoring and collection plan of site 180 is prepared to proactively alert responsible parties (i.e., first responders) before or immediately when events or abnormalities occur within site 180. To this end, one or more detection sensors 160 are strategically positioned within site 180, each communicatively coupled with site observer 120. Detection sensors 160 may include a combination of audio (e.g., microphones), video (e.g., security cameras) and ground sensors (e.g., motion sensors, flame detectors, methane detectors, temperature sensors) that are deployed inside and outside of buildings within site 180, where the location of each detection sensor 160 is strategically selected based on the vulnerability assessment, security requirements and the monitoring/collection plan.

Therefore, and referring to FIG. 5, sensors 160 are for example selected to continually or periodically monitor sound, light levels, chemical content of the air, and other parameters. Each sensor position 212 may have more than one type of sensor 160, and may have intelligence (i.e., include processing capability) to identify complex conditions and events at site 180. Site observer 120 monitors, and may further configure and control each sensor 160, to obtain data corresponding to real-time conditions and events at site 180. Each detection sensor 160 may include circuitry that has programmable functionality to allow characteristics of the sensor and detection to be remotely programmed and reprogrammed. By way of example, each detection sensor 160 may include a computer or microcontroller that controls functionality of sensor 160. Sensor signature analyzer 502 then monitors detection sensors 160 for specific anomalies or abnormalities within site 180, and which may depend upon specific position within site 180. In an embodiment, a sampling rate and communication frequency of detection sensor 160 may be configured by sensor signature analyzer 502 and/or analytics engine 130.

Thus, sensor signature analyzer 502 receives and processes data from sensors 160 to identify site anomalies 503. In one embodiment, sensor signature analyzer 502 is configured to recognize certain sounds within audio collected by one or more microphone type sensors 160. In another embodiment, sensor signature analyzer 502 is configured to recognize certain environmental changes detected by environmental sensors 160, where such environmental changes are indicative of events at site 180. In another embodiment, a sensor 160 is a camera and sensor signature analyzer 502 is configured to recognize fire based on images from this camera.

Sensor signature analyzer 506 may also monitor social media (e.g., Twitter, Facebook, and so on) traffic to identify emerging threats relating to site 180, generating site abnormality 503 when such a threat is identified. For example, sensor signature analyzer 502 may include a social media engine 580 (see, e.g., connection between site observer 120 and external data 192, FIG. 1) for monitoring social media, news media, and other publicly available data and information feeds, for (possibly even real time) information corresponding to site 180 (e.g., by name, geographic location, site function, and so on) to identify and or predict event and site anomalies 503 before they occur.

In one embodiment, detection sensors 160 include at least one panic button (e.g., a fire alarm button, emergency call button, and so on) deployed within site 180. In another embodiment, detection sensor 160 is an application running on one or more smart phones or other portable devices that include a panic button to raise an alert. Accordingly, key personnel operating within site 180 may activate the panic button or be equipped with a smart phone running the application to allow rapid response to emergency situations detected by those personnel.

Sensor signature analyzer 502 monitors detections sensors 160 continuously to identify anomalies 503 within site 180 as they occur. In one embodiment, accordingly sensor signature analyzer 502 has learning and artificial intelligence software to improve its functioning over time.

As noted previously, detections sensors 160 may include one or more security cameras positioned within site 180, where each security camera operates to send image streams (images sent periodically) to sensor signature analyzer 502. Sensor signature analyzer 502 processes received images to determine site anomalies 503 such as one or more of thermal (e.g., heat from fire) and muzzle flashes.

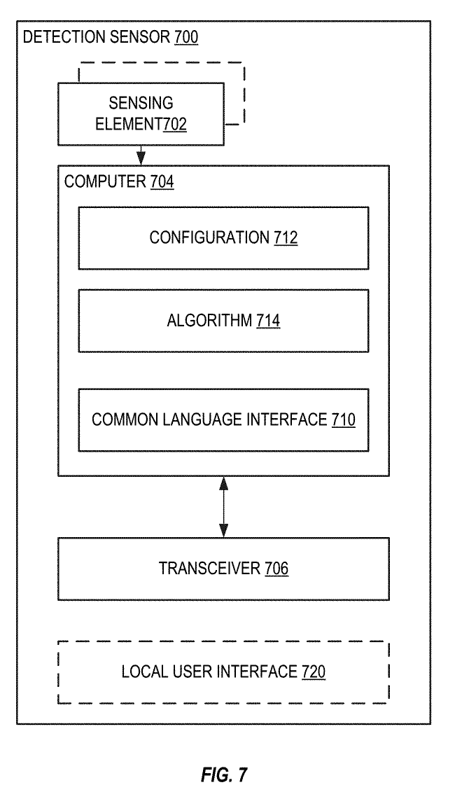

FIG. 7 shows one example detection sensor 700 that represents detection sensor 160 of FIG. 1. Detection sensor 700 has at least one sensor element 702 (e.g., a microphone, temperature sensor, an IR sensor, a camera, and so on), a computer 704 that provides intelligence to sensor 700, and a transceiver 706 that allows sensor 700 to communicate with site observer 120. Computer configured with a common language interface 710. Computer 704 includes a common language interface module 710 that facilitates communication with site observer 120. A common language interface (CLI) is a plain language (i.e., plain text) structured architecture for interfacing disparate devices. For example, a CLI is used by telephone companies to allow different equipment on the telephone network to talk to one another. Within detection sensor 700, a CLI 710 may generate a messages, sent to site observer 120, to indicate an alarm, where the message has a format such as:

ALM (Alarm: root level category)

ALM-MN (Alarm-minor, second level category)

ALM-MAJ (Alarm-major, second level category)

ALM-CRI (Alarm-critical, second level category)

Each component of system 100 may include a corresponding CLI to facilitate communication between different types of component. Continuing with the above alarm example, drone 150 may generate a message such as one of:
ALM-MAJ-GUA-UAV (Alarm-major-Guardian-UAV, a major alarm from a UAV)
ALM-MAJ-GUA-UAV-ASK (Alarm-major-Guardian-UAV-Askew Elementary School, a major alarm from the UAV at Askew Elementary School)

CLI (e.g., CLI 710) allows conversion from any and all languages used by different components (e.g., sensors 160, drone 150, and so on) to be ingested into analytic engine 130 (e.g., self-learning) and also provides a common output to control reactionary devices (e.g., drone 150, etc.).

Common language interface 710 is used by sensor 700 for communicating with sensor signature analyzer 502. In one embodiment, computer 704 includes and utilizes encryption algorithms 714 for securely communicating with site observer 120. Transceiver 706 allows a configuration 712 of detection sensor 700 to be remotely configured by site observer 120. In one embodiment, detection sensor 700 includes a local user interface 720 that allows configuration 712 to be locally configured (e.g., by a user.

In one specific example, detection sensors 160 include at least one microphone positioned within site 180. Each microphone operates to digitize sounds detected within site 180 and sends these digitized sounds to sensor signature analyzer 502. Sensor signature analyzer 502 processes the received digitized sounds to identify one or more of gun shots, shouts, and screams. In one embodiment, detection sensors 160 include at least three microphones positioned at different locations within site 180 and sensor signature analyzer 502 processes the digitized sounds from the three microphones to identify and determine a location of a gunshot within site 180 based upon triangulation. Sensor signature analyzer 502 then generates site abnormality 503 to indicate the location of the gun shot within site 180.

Detection sensors 160 may include other types of sensor without departing from the scope hereof.

### Drone

Drone controller 504 is wirelessly communicatively coupled with drone 150 and controls drone 150 to perform reconnaissance of site 180 as needed (e.g., in baseline operations, if desired, but also after detection of an abnormality to capture real time data from that location). In response to directives from analytics engine 130, for example, drone controller 504 operates to load one or more flight plans 505 into drone 150 and initiates automatic deployment of drone 150, which then autonomously flies one or more selected flight plans 505, and receives aerial imagery captured by drone 150 and accompanying flight data (e.g., position and orientation of drone 150 and field of view information of corresponding captured imagery). Offsite drones (e.g., drone 150 and/or drone 550, FIG. 5) may be available to respond to detected events at site 180. For example, where two or more sites are near one another, site sentinel systems 100 operating at each site may cooperatively share a strategically positioned (e.g., at a central location) drone 150 as a shared resource. Where drone 150 is configured with additional sensors, this sensor data, together with the associate flight data, may be provided to sensor signature analyzer 502 for further analysis in coordination with data from sensors 160.

### Respond

Analytics engine 130 includes a situation analyzer 506 and a graphic generator 508. Situation analyzer 506 includes learning intelligence that processes site anomalies 503 determined by site observer 120, external data 192, imagery 194, and digital representation 112, to generate situation data 507 corresponding to awareness of a current situation at site 180. Analytics engine 130 generates output 170 based upon digital representation 112 and situation data 507 to reflect the currently determined situation at site 180, which might include a detected abnormality.

FIG. 6 shows one example output 600 corresponding to digital representation 112 of FIG. 2 as enhanced by graphics generator 508 of FIG. 5 based upon determined situation data 507. Output 600 may represent output 170 of FIGS. 1 and 2. FIGS. 5 and 6 are best viewed together with the following description. Output 600 is similar to output 300 of FIG. 3, but includes additional dynamically generated symbols based upon situation data 507.

In one example of operation, sensor signature analyzer 502 identifies and locates a gunshot within site 180 and generates abnormality 503. Analytics engine 130 evaluates abnormality 503 together with digital representation 112 and determines that a situation is occurring at site 180. Analytics engine 130 then instructs drone controller 504 to deploy drone 150 using flight plan 505 to capture live imagery 194 of the determined location of the gunshot. Drone controller 504 deploys drone 150 to follow flight plan 505 such that at location 604 along flight plan 505, drone 150 is positioned to capture imagery 194 of the location of the gunshot as indicated by event 602. That is, within moments of the gunshot being detected, deployment of drone 150 captures live imagery of the determined location of the gunshot. Drone 150 may continue to follow flight plan 505 such that all relevant imagery of activity is captured of site 180.

Communication within system 100 may be encrypted and secure, whether via wired and/or wireless media. Analytics engine 130 may provide relevant captured imagery 194 within output 170. For example, graphic generator 508 may overlay relevant portions of imagery 194 onto output 600 as a movable window.

Output 170 is for example sent to a designated Real-Time Command Center (RTCC) 560 in less than thirty seconds from detection of abnormality 503 at site 180. In one embodiment, output 170 is streamed securely and wirelessly to the cloud, where it may be accessed from RTCC 560 and any designated Mobile Command Post (MCP) 562. Additionally, and as a backup, if RTCC 560 and/or MCP 562 cannot receive output 170, portable Tactical Operations Centers (TOC) 564 may be used to access output 170.

Analytics engine 130 utilizes graphic generator 508 to enhance digital representation 112 with situational data 507 to generate output 170 such that real-time information is available via one or more of RTCC 560, MCP 562 and TOC 564. For example, where first responders each carry a portable TOC 564, each may receive live video from drone 150 and digital representation 112 enhanced by symbols indicative of the current situation (and position of anomalies) at site 180.

As emergency personnel (hereinafter responders) arrive at site 180 and use their location enabled device (e.g. GPS enabled smartphone and/or tablet, or other locating technology), each of the responders' locations determined and displayed as symbol 606 with label 603 on output 600. That is, as responders move within site 180, output 170 reflects their current positions such that each responder may be aware of the location of all other responders within and around site 180.

Drone 150 may also be controlled via one or more of RTCC 560, MCP 562 and TOC 564 to perform specific tasks. Continuing with the example of FIG. 6, RTCC 560 may command drone 150 to position itself at location 604 to capture live video of determined location of the gunshot, indicated by event 602, such that each responder may view that location even when it is not viewable from their current location. This is especially valuable in cases where a first responder cannot position themselves safely to see a specific doorway or an area of interest at site 180.

Additional multi-mission drones may be deployed at site 180 and/or provided to responders to extend flight operations, area coverage, and add different platforms and sensors or provide manual flight control. These additional drones may communicate with system 100 and operate similarly to drone 150.

In one embodiment, drone controller 504 is configured within drone 150. In another embodiment, drone controller 504 is configured within a computer implementing analytics engine 130. Drone controller 504 and/or analytics engine 130 may be located remotely from site 180.

System 100 operates to record data and events that occur in response to each abnormality 503, thereby allowing reviewers to learn from each event. Analytic engine 130 may be self-learning and automatically adjust algorithms for programming sensors 160 and selecting flight plans 505 of drone 150 for different situations. For example, modifications and adjustments may be made to the monitoring, collection and sensor implementation plan based upon review of a previous event.

Analytics engine 130 may utilize graphic generator 508 to further enhance digital representation 112 as output 170. As drone 150 follows a selected flight plan 505 to capture live imagery 194 of site 180, these video images may be automatically scaled and overlaid with at least part of digital representation 112 to provide output 170.

In one embodiment, imagery 194 of site 180, from drone 150 and/or other sources, may include certain data, such as facial features, of perpetrators. A facial recognition tool (e.g., within situation analyzer 506) may be used to process at least part of imagery 194 to identify the perpetrators and/or compare the captured facial images against a database of known individuals who have been cleared to be in the area where the video was captured. For example, a captured image of a face may be checked against a database of employees' faces to determine if face belongs to an employee or not. Thus, situation analyzer 506 may automatically determine and label individuals within imagery as “friend” or “foe”.

In another embodiment, situation analyzer 506 and/or signature analyzer 502 may include video processing to recognize weapons within imagery 194. For example, where imagery 194 is captured by drone 150, drone controller 504 may automatically control drone 150 to follow a gun recognized by sensor signature analyzer 502, thereby overriding any currently followed flight plan of drone 150. Further, drone controller 504 may direct drone 150 to a particular location to capture imagery 194 when sensor signature analyzer 502 recognizes a gun within imagery from other sources, such as stationary surveillance cameras. For example, the drone 150 may capture additional imagery of the gun and may be able to follow its movement too.

As a situation at site 180 develops, site observer 120 detects anomalies 503 and events (e.g., gun shots, shouting, yelling, environmental changes, fire, flood), analytics engine 130 automatically updates digital representation 112 and generates output 170 with time-stamped indicators that portray the location and type of the abnormality 503 and event. Output 170, with these updates, is instantly available to responder GUIs 142, RTCC 560, MCP 562, TOC 564, and off-site personnel 570. Grid numbers assists relevant responders to the location of the abnormality.

In one embodiment, through responder GUI 142, any responder may direct drone 150 to fly to their location. Optionally, such control is granted through one or more of RTCC 560, MCP 562, and TOC 564, or based upon an authority level assigned to that particular responder. Sentinel system 100 stores imagery 194 captured before, during, and after, a situation at site 180. In this embodiment, analytics engine 130 allows any one or more of RTCC 560, MCP 562, TOC 564, responder GUIs 142, and off-site personnel 570 to allow for change detection of real-time versus historical conditions.

Thus analytics engine 130 may detect change in real-time imagery 194 as compared to historical imagery. In this case, graphic generator 508 for example draws a yellow box on output 170 around items that have changed (e.g., for RTCC 560, MCP 562, TOC 564, responder GUIs 142, and off-site personnel 570). In this way, analytics engine 130 may provide notification of changes such as cut fences, disturbed ground, broken doors, and so on. Analytics engine 130 may also provide a landscape status update corresponding to previously mapped features of site 180 (e.g., such as were captured during the baseline phase) to show changes in condition of sensors 160, locations of events, and areas where responder activity has occurred, to provide an operating picture, via output 170, for responders and command center decision-makers.

In another example, analytics engine 130 may show, through use of graphics generator 508, a shift in a situation within site 180, such as where detected gunfire has evolved into a fire event evidenced by additional sensors 160 indicating a rapid out-of-control expansion of fire.

Analytics engine 130 may correlate a previous situation and/or abnormality 503 to changes detected within imagery 194 prior to, and during, the situation or event to identify pre-staged conditions (e.g., where an area has been prepared in preparation for intrusion), and to update corresponding locations within digital representation 112 to indicate high-risk areas of site 180. That is, analytics engine 130 may predict an event by identifying changes within imagery that lead up to the event.

System 100 dramatically increases the ability for businesses and public safety organizations to proactively prepare and respond to risks that threaten assets, operations and people by providing situational awareness as a service that helps mitigate risk, manage incidents and enhance public safety and business operations.

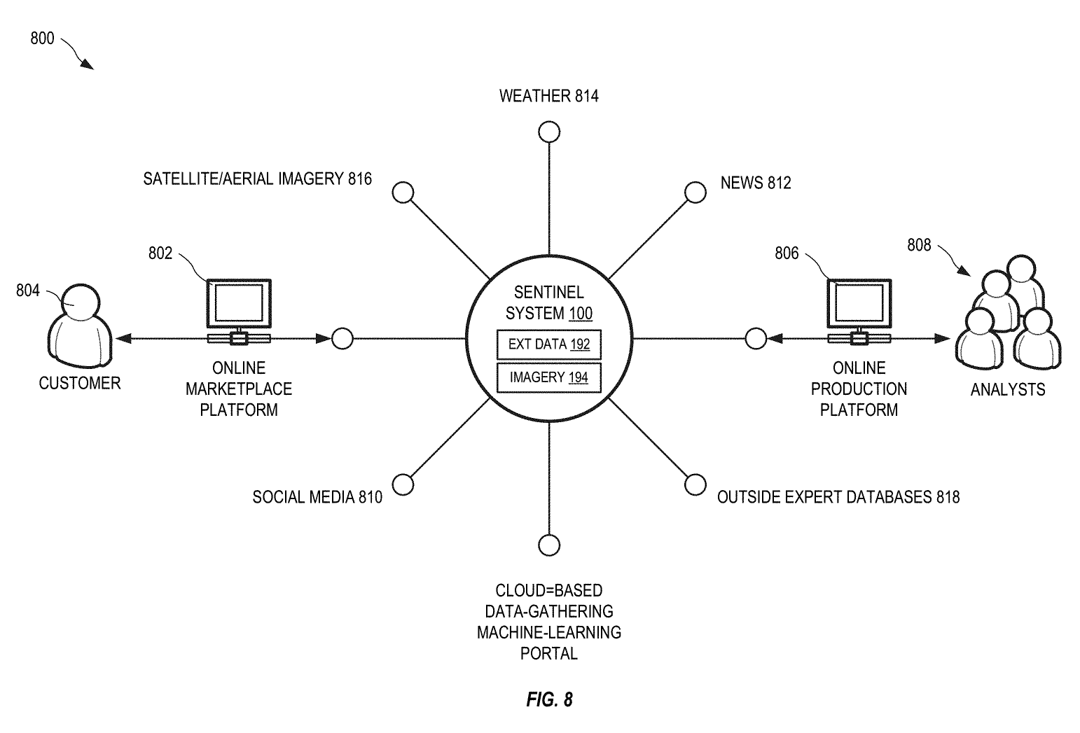

FIG. 8 is a schematic illustrating one example marketplace 800 for sentinel system 100 of FIG. 1. Marketplace 800 shows sentinel system 100 configured with an online marketplace platform 802 that is accessible by a customer 804. Online marketplace platform 802 interacts with customer 804 to receive the customer's needs and to provide output to customer 804. Marketplace 800 also shows sentinel system 100 configured with an online production platform 806 that provides an interactive interface to a plurality of analyst 808. Online marketplace platform 802 and online production platform 806 may allow customer 804 and analysis 808 to communicate in an automated fashion, for example to both exchange ideas and/or transfer payment. In one example of operation, customer 804 may request a product, wherein sentinel system 100 notifies one or more analysts 808 to create that product. When the product is configured and available within sentinel system 100, customer 804 may be notifies vial online marketplace platform 802.

In an embodiment, sentinel system 100 is cloud-based (i.e., configured with Internet access) and operates to gather, in real-time, external data 192 from multiple input sources (social media 810, news feeds 812, weather 814, commercial and unclassified governmental satellite imagery 816, expert knowledge databases 818, and so on). In one embodiment, sentinel system 100 processes, at least periodically, external data 192 and/or imagery 194 to determine if an event (e.g., a crisis and/or abnormality such as any human caused event including an attack, vandalism and/or a natural event such as weather, flooding, fire, and so on) has occurred about which the one or more analysts 808 may create a product (e.g., imagery based analytic reports providing assessment and detailing change). For example, one or both of site observer 120 and analytics engine 130 may continually receive and process imagery 194 and other external data 192 to identify new events therein. When sentinel system 100 identifies a new event, determines that a product should be created for that event, and determines that materials are available to create that product, then sentinel system 100 sends an automatic notification via online production platform 806 to analysts 808 such that the analyst may verify and define the product within sentinel system 100. For example, analysis 808 may configure one or both of site observer 120 and analytics engine 130 to provide information to the product. For example, the analysts 808 may defines one or both of a specific geography and/or a specific topic, wherein sentinel system 100 identifies relevant information from gathered data (i.e., previously gathered and currently received data). Sentinel system 100 may also identify one or more customers (e.g., customer 804) that are subscribed to receive products covering this specific geography and/or topic, wherein the newly created product is made available to these customers via online marketplace platform 802. For example, online marketplace platform 802 may send an automatic notification that a new product is available to appropriate customers (e.g., customers subscribed to received notifications about events and/or products for a particular geographic area and/or specific topic). Customers 804 may then interacts with online marketplace platform 802 to download the product.

Changes may be made in the above methods and systems without departing from the scope hereof. For example, in one embodiment site 180 corresponds to a maritime location, where sentinel system 100 is configured with appropriately typed sensor 160 and drones 150 for observing the maritime site. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. Site sentinel system, comprising:
a digital representation of a site;
at least one detection sensor for monitoring the site;
a sensor signature analyzer for processing data from each detection sensor to identify site abnormalities; and
analytics engine for generating output that synthesizes the digital representation with graphics positioning site abnormalities.

2. Site sentinel system of claim 1, further comprising:
at least one drone for providing aerial reconnaissance of the site; and
a drone controller for directing the drone to conduct the aerial reconnaissance in response to identified site abnormalities.

3. Site sentinel system of claim 1, the digital representation comprising one of satellite imagery of the site, aerial photography of the site, or an illustration of the site.

4. Site sentinel system of claim 2, the aerial reconnaissance comprising a flight pattern set by the drone controller over the site.

5. Site sentinel system of claim 2, the analytics engine including the sensor signature analyzer and drone controller and being remote from the site.

6. Site sentinel system of claim 5, the analytics engine determining how often to collect data (a) of the digital representation, (b) from each detection sensor, (c) from drone aerial reconnaissance.

7. Site sentinel system of claim 1, the detection sensor comprising one or more security cameras.

8. Site sentinel system of claim 7, wherein the sensor signature analyzer determines one or both of fire and muzzle flash as site abnormalities from images or video from the security cameras.

9. Site sentinel system of claim 1, each detection sensor having a common language interface and encryption for securely communicating with the sensor signature analyzer.

10. Site sentinel system of claim 1, the detection sensor comprising at least one microphone.

11. Site sentinel system of claim 10, wherein the at least one microphone comprises at least three microphones and the sensor signature analyzer determines gunshot source triangulation as site abnormality from sound data of the microphones.

12. Site sentinel system of claim 1, each detection sensor being remotely programmable.

13. Site sentinel system of claim 1, the detection sensor comprising a social media engine for monitoring social media about the site to identify site abnormalities.

14. Site sentinel system of claim 1, the analytics engine generating the output via one or more of: web portal, physical media, FTP, web service, email, briefcase.

15. Site sentinel system of claim 1, the analytics engine cataloging data of the site sentinel engine in time linked format for recovery and access from the cloud, with appropriate credentials.

16. Site sentinel system of claim 15, the analytics engine requesting recapture of data as the digital representation to support a particular date corresponding to site abnormalities.

17. Site sentinel system of claim 15, the analytics engine automatically selecting satellite imagery of the date.

18. Site sentinel system of claim 1, wherein the site is a maritime location.

19. Method for determining baseline risks at a site, comprising:
capturing a digital representation of the site;
determining a property outline of the site;
determining at least one key asset outline of the site;
determining one or more ports to the site and/or to the key asset; and
synthesizing data representative of the property outline, key asset and ports as graphic data with the digital representation as output graphics useful in responding to site abnormalities at the site.

20. A method for identifying and marketing an information product, comprising:
gathering, in real-time, external data and imagery;
processing the gathered external data and imagery to identify an event of interest;
interacting, via an online production platform, with at least one of a plurality of analysts to define the information product;
generating the information product based upon the gathered external data and imagery corresponding to the identified event of interest; and
marketing the information product to one or more customers through a marketplace platform.
